(19) United States
(12) Patent Application Publication
(10) Pub. No.: US 2005/0180276 A1
(43) Pub. Date: Aug. 18, 2005

(54) Optical information recording and reproducing apparatus

(75) Inventors: Fumito Watanabe, Yokohama-shi (JP); Hirotake Ando, Tokyo (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 11/046,867

(22) Filed: Feb. 1, 2005

(30) Foreign Application Priority Data
Feb. 17, 2004 (JP) 2004-039944
Mar. 10, 2004 (JP) 2004-067406

(51) Int. Cl. G11B 7/00

(52) U.S. Cl. 369/44.29; 369/44.32

(57) ABSTRACT

The present invention provides an optical information recording and reproducing apparatus which is capable of performing accurate adjustment of a variety of parameters or offsets in a minimum amount of time, even when vibrations are applied to the apparatus, and even when there are flaws on a recording medium, during adjustment of the recording or reproduction parameters or during adjustment of the offsets in servo control at the time of startup, exchanging the recording medium, and the like. The adjustment of recording or reproduction parameters or offsets of the servo control based on the reproduction index showing the quality of a reproduction signal is performed by correcting or invalidating the reproduction index when there is an abnormality in servo control.

### BACKGROUND OF THE INVENTION

1. Field of the Invention

The present invention relates to an optical information recording and reproducing apparatus that records information onto and reproduces information from an information recording medium such as an optical disk, and specifically to a technology of setting a servo parameter or a parameter concerning recording and reproduction such as laser power.

2. Related Background Art

For an optical disk apparatus using an optical disk as a recording medium when turning on electric power of the apparatus, exchanging the optical disk, and the like, in order to obtain the best recording and reproduction signal characteristics, it has conventionally been necessary to adjust a variety of parameters such as offset values to be added to focus and tracking servos, laser power, and a spherical aberration correction amount.

The parameters are conventionally set to values at which the degree of modulation in a reproduction signal becomes a maximum, and at which the amplitude of a tracking error signal becomes a maximum. However, when there is a flaw on the optical disk during parameter adjustment, and when vibrations are applied to the optical disk apparatus, it may be impossible to adjust the parameter accurately.

Apparatuses like that disclosed in Japanese Patent Application Laid-Open No. H8-287494 have been made in order to solve the above problems. FIG. 13 shows a configuration of the apparatus of Japanese Patent Application Laid-Open No. H8-287494.

Here, a method of adjusting a focus offset is described. First, when electric power to the apparatus is turned on or when an optical disk 1 is exchanged, a controller 7 drives a spindle motor 2, and a laser (not shown) within an optical pickup 3 is turned on.

A focus error generation circuit 4 generates a focus error signal from reflected light from the laser light, and a phase compensation filter 5 performs phase compensation processing on the focus error signal. An actuator driver 6 then applies a driving signal corresponding to the focus error signal to an actuator (not shown) within the optical pickup 3. An objective lens is thus driven to perform focus control on a recording surface of the optical disk 1. Tracking control is then performed to a desired track on the recording surface of the optical disk 1. Detailed description of specific processing content of the tracking control is omitted.

Adjustment of parameters such as a focus offset and a tracking offset is performed after the focus control and the tracking control have been performed. Here, description is made with respect to the adjustment of the focus offset as an example. First, a direct current offset value is outputted from an offset addition circuit 8 so as to add the direct current offset to the focus error signal. The direct current offset value is set, for example, to a value corresponding to 1 μm as a focus offset amount.

After the focus offset is added, an RF signal generation circuit 9 generates an RF signal that shows the total amount of light reflected from the optical disk 1. The RF signal is inputted to an amplitude value detection circuit 10, and the amplitude of the RF signal is detected. For example, one method of detecting the amplitude value uses the average value of several values sampled at predetermined periods as the amplitude value of the RF signal. The detected amplitude value is stored by an amplitude value storage circuit 11 as an RF signal amplitude value corresponding to an offset value where the focus offset amount is equal to 1 μm.

Next, the controller 7 performs control so as to change the output of the offset addition circuit 8. The focus offset at this point is set to a value at which the focus offset amount corresponds to 0.9 μm. The focus offset value is thus changed in a stepwise manner every 0.1 μm in a range of +1 μm to −1 μm. The RF signal amplitude is detected and stored at each of the offset values. After detection of the RF signal amplitudes corresponding to all of the focus offset values is completed, the controller 7 sets the output of the offset addition circuit 8 while that the focus offset value at the time when the detected RF signal amplitude is largest is set as an optimal focus offset value, whereby adjustment of the focus offset value is completed.

Processing performed when detecting vibrations and a flaw is explained next with reference to the flowchart of FIG. 14. First, focus offset adjustment is started (step S41). While the focus offset value is adjusted, a vibration/flaw detection circuit 12 detects the size of a vibration applied to the optical disk apparatus, and detects the presence or absence of a flaw on the optical disk 1 (step S42). For example, one method of detecting the size of the vibration and the flaw is to set a threshold for the size of the RF signal, and when the size of the RF signal exceeds the threshold, it is determined that vibrations have been applied to the optical disk apparatus or that there is a flaw on the optical disk 1. The vibration/flaw detection circuit 12 outputs an adjustment stop signal when the vibration or the flaw is detected (step S43). When the adjustment stop signal is inputted to the controller 7, the controller 7 immediately causes the amplitude value detection circuit 10 to stop detecting the amplitude of the RF signal.

The controller 7 then changes the position of the optical pickup 3 to a location having neither vibration nor flaw (step S44), and focus offset value adjustment is started from the beginning. When a stop signal has been inputted to the controller, immediately the controller 7 causes the amplitude value detection circuit 10 to stop detecting the amplitude of the RF signal. Focus offset processing is completed when neither vibration nor flaw is detected (step S45).

In the optical disk apparatus, as described above, adjustment of parameters, which is performed at time such as when electric power to the optical disk apparatus is turned on or when the optical disk 1 is exchanged, is performed accurately by stopping the parameter adjustment when vibrations are applied to the optical disk apparatus or when a flaw is found on the optical disk 1. The adjustment described above can also be applied to adjustment of tracking offset values and adjustment of laser power.

With the adjustment disclosed by Japanese Patent Application Laid-Open No. H8-287494, accurate adjustment of each of the parameters can be performed even if vibrations are applied to the optical disk apparatus, or there is a flaw on the optical disk. However, the following problems also exist.

That is, with the adjustment disclosed by Japanese Patent Application Laid-Open No. H8-287494, focus offset adjustment processing at the time of, for example, supplying electric power to the optical disk apparatus is performed again from the beginning when the apparatus receives the influence of a vibration or a flaw even one time during adjustment. In this case, the startup time of the optical disk apparatus becomes longer. Further, a constitution that performs focus offset adjustment again from the beginning when a vibration or a flaw is detected may cause a problem that the focus offset.adjustment will not be able to finish, for example, if the vibration applied to the optical disk apparatus is intermittently applied every 0.3 sec and it takes 0.3 sec to perform the focus offset adjustment from start to finish.

In addition, it is preferable that processing of adjusting the recording power of the laser be performed only in a test region in order to preserve the characteristics of the medium. However, in an optical disk apparatus like a conventional technique in which the adjustment position is changed when the apparatus receives the influence of a vibration or a flaw, there is a problem that recording power adjustment processing becomes impossible if there is a flaw long enough to cover the entire test region.

### SUMMARY OF THE INVENTION

According to the present invention, there is provided an optical information recording and reproducing apparatus, which is capable of performing accurate adjustment of a variety of parameters in a minimum amount of time, even when vibrations are applied to the apparatus, and even when there are flaws on a recording medium, during adjustment of the parameters at the time of startup, exchanging the recording medium, and the like.

The optical information recording and reproducing apparatus according to the present invention is an optical information recording and reproducing apparatus which performs recording of information by irradiating a recording medium with spot light, and performs reproduction of information by receiving reflected light from the recording medium, the optical information recording and reproducing apparatus including:

a servo error signal generating circuit for generating a servo error signal based on light reflected by the recording medium;

a servo control circuit for performing servo control of the spot light based on the servo error signal;

a reproduction index detection circuit for detecting a reproduction index showing the quality of a reproduction signal from the recording medium; and

an adjustment circuit for performing adjustment of an offset value of the servo control circuit, or performs adjustment of a recording and reproduction parameter, based on the reproduction index,

wherein the adjustment circuit performs adjustment by correcting or invalidating the reproduction index when there is an abnormality in the servo control.

### BRIEF DESCRIPTION OF THE DRAWINGS

FIG. 1 is a block diagram that shows the first embodiment of an optical information recording and reproducing apparatus according to the present invention;

FIG. 2 is a flowchart that explains operation of the first embodiment;

FIG. 3 is a graph that shows a change in the level of a focus error signal under vibrations;

FIG. 4 is a graph that explains a method of calculating an optimal focus offset value from the amplitude of an RF signal;

FIG. 5 is a block diagram that shows the second embodiment of the present invention;

FIG. 6 is a flowchart that explains operation of the second embodiment;

FIG. 7 is a graph that shows a change in the level of a focus error signal under vibrations;

FIG. 8 is a graph that shows a change in the level of an RF signal under vibrations;

FIG. 9 is a block diagram that shows the third embodiment of the present invention;

FIG. 10 is a flowchart that explains operation of the third embodiment;

FIG. 11 is a graph that shows a change in the level of a focus error signal when switching focus offset values;

FIG. 12 is a graph that shows a change in the level of the focus error signal under minute vibrations;

FIG. 13 is a block diagram that shows a conventional optical disk apparatus;

FIG. 14 is a flowchart that explains operation of the conventional optical disk apparatus;

FIG. 15 is a block diagram of the fourth embodiment of an optical information recording and reproducing apparatus according to the present invention;

FIG. 16 is a flowchart that shows operation of the fourth embodiment;

FIG. 17 is a diagram that shows a standard relationship between focus offset and reproduction signal amplitude when an optimal focus point is set to zero and the focus point is moved;

FIG. 18 is a diagram that shows a focus offset and the inverse of the amplitude of a reproduction signal;

FIG. 19 is a flowchart that explains the fifth embodiment of the present invention;

FIG. 20 is a block diagram that shows the sixth embodiment of the present invention;

FIG. 21 is a flowchart that shows operation of the sixth embodiment;

FIG. 22 is a flowchart that explains the seventh embodiment of the present invention;

FIG. 23 is a block diagram that shows the eighth embodiment of the present invention; and

FIG. 24 is a circuit diagram that shows an equalization filter.

### DESCRIPTION OF THE PREFERRED EMBODIMENTS

Preferred embodiments for implementing the present invention are described next in detail with reference to the appended drawings.

First Embodiment

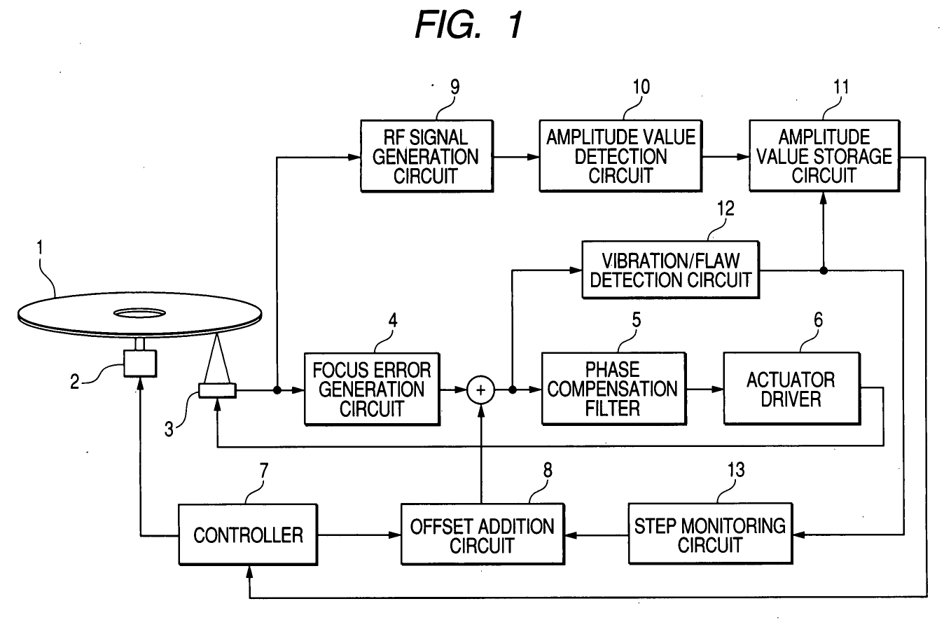

FIG. 1 is a block diagram that shows the constitution of the first embodiment of an optical disk apparatus according to the present invention. The blocks of FIG. 1 having the same function as those of FIG. 13 are denoted by the same reference numerals. Similarly to the conventional example, when performing operations such as turning on electric power to the apparatus and exchanging an optical disk 1 in this embodiment, a controller 7 first drives a spindle motor 2, and a semiconductor laser (not shown) within an optical pickup 3 is turned on.

Focus control and tracking control are performed next on a predetermined track on a recording surface of the optical disk 1. After focus control and tracking control are performed, adjustment of parameters such as a focus offset and a tracking offset is performed. Description is made here with respect to the adjustment of the focus offset as an example.

Similarly to the conventional technique described above, in a method of adjusting the focus offset value, from an offset addition circuit 8, focus offset values, for example, of changing in a stepwise manner every 0.1 μm from −1 μm to +1 μm is inputted and added to focus error signals. Further, an amplitude value detection circuit 10 detects amplitude values of RF signals corresponding to the respective focus offset values, and an amplitude value storage circuit 11 stores the detected values. The controller 7 calculates an optimal focus offset value from the stored RF signal amplitude values, and adjusts the focus offset value so that the offset addition circuit 8 outputs the optimal focus offset value.

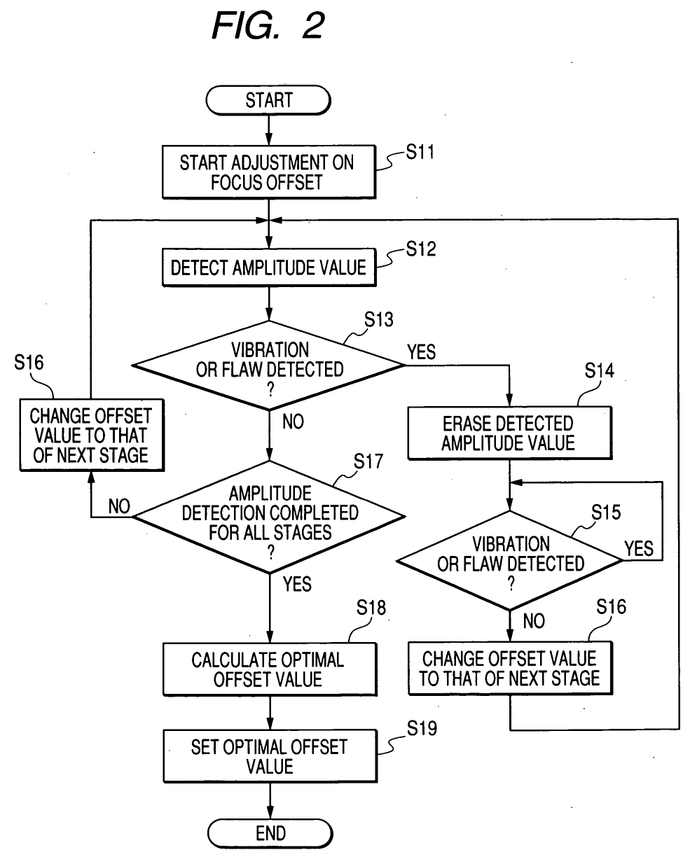

Processing content in this embodiment at the time of receiving the influence of a vibration or a flaw is explained next with reference to the flowchart shown in FIG. 2. First, focus offset adjustment is started, and the initial offset value used for adjustment is set to −1 μm (step S11). Further, the amplitude value detection circuit 10 detects the amplitude of an RF signal from the RF signal generation circuit 9 for a predetermined period of time (step S12). At this point, an average amplitude value of reproduction signals, for example, on the order of 4 ms may be detected. During this 4 ms, the vibration/flaw detection circuit 12 detects the size of vibrations applied to the optical disk apparatus, and detects the presence or absence of a flaw on the optical disk 1 (step S13). One method of detecting the size of a vibration or a flaw is, for example, to set a threshold value for the size of the focus error signal. It is determined that a vibration has been applied to the optical disk apparatus, or that there is a flaw on the optical disk 1, when the size of the focus error signal exceeds the threshold value.

When there is neither vibration nor flaw, the offset value is set to the offset value of the next step, for example, −0.9 μm (step S16), and processing is again performed from step S12. When amplitude detection is completed by being performed in 21 steps each having 0.1 μm, from −1 μm to 1 μm (step S17), the controller 7 calculates the focus offset value having the largest RF signal amplitude value detected during the 21 steps (step S18). The calculated focus offset value is set in the offset addition circuit 8 as an optimal focus offset value (step S19).

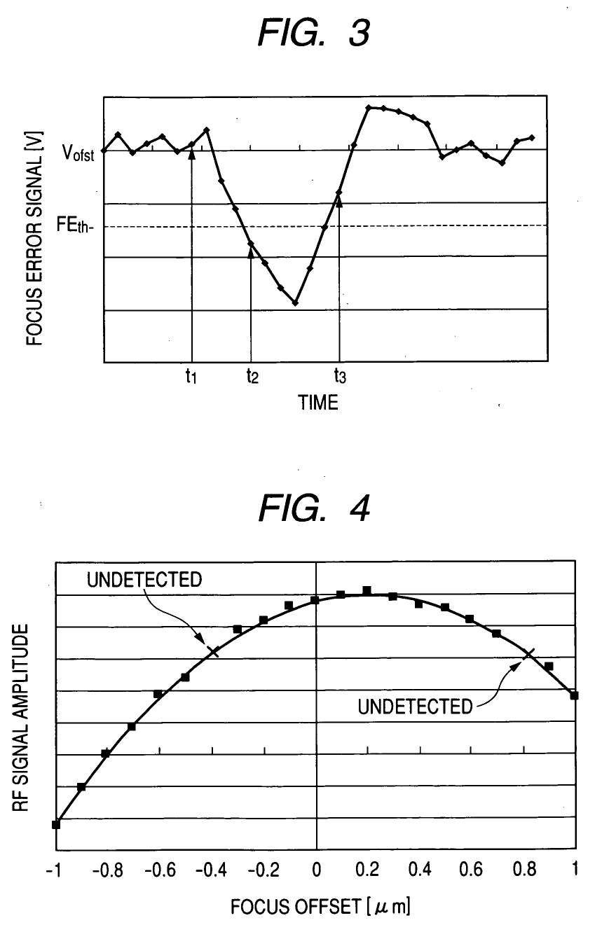

Processing for cases where a vibration or a flaw is detected during step S13 is explained next. An example in which vibrations are applied to the optical disk apparatus is explained here with reference to FIG. 2 and FIG. 3. When vibrations are applied at a point t1 in FIG. 3, the focus error signal becomes a waveform like that shown in FIG. 3. Solid circles in FIG. 3 show points sampled by a digital servo. When a threshold for the size of FEth− is set for the focus error signal level as shown in FIG. 3, the vibration/flaw detection circuit 12 determines that a vibration has been applied to the apparatus at a point t2, and the RF signal amplitude value detected at the point t2 is erased from the amplitude value storage circuit 11 (step S14).

When Vofst is a value equivalent to a focus offset amount of −0.4 μm in FIG. 3, FEth− is set to a value equivalent to a focus offset of −0.5 μm, for example. When vibrations are detected after the RF signal amplitude is detected while an offset amount equivalent to a focus offset amount of −0.4 μm is applied, the detected amplitude value when the focus offset is −0.4 μm is erased.

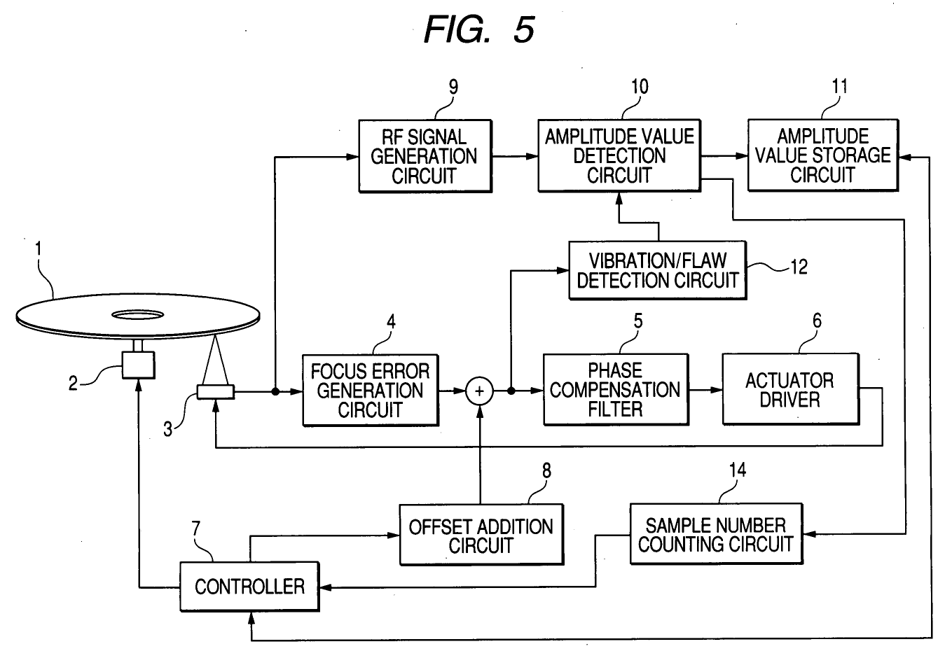

Once the vibrations become undetectable (step S15), a step monitoring circuit 13 outputs the offset value of the next step to the offset addition circuit 8 (step S16). In other words, at a point t3 in FIG. 3, a focus offset value equivalent to −0.3 μm in the next step is outputted to the offset addition circuit 8. That is, as shown in FIG. 4, the RF signal amplitude when the focus offset amount is −0.4 μm is not detected, and processing shifts to detection of the RF signal amplitude in the next focus offset amount of −0.3 μm.

Detection of the amplitude of the RF signal corresponding to the offset value when vibrations are detected is thus not performed. Only RF signal amplitude values corresponding to offset values where vibrations were not detected are successively stored in the amplitude value storage circuit 11. Next, when detection of all of the amplitude values for a predetermined range (for example, from −1 μm to 1 μm) is completed (step S17), a quadratic curve may be approximated as shown in FIG. 4 to determine the optimal focus offset value from the plurality of RF signal amplitude values in the offset values where vibrations were not detected (step S18).

In other words, even when vibrations are applied to the optical disk apparatus at the time of the focus offset amount set to −0.4 μm and 0.8 μm as shown in FIG. 4 and the there are no detected values for the amplitude of the RF signal, in the case of FIG. 4, it is determined that the focus offset value equivalent to a focus offset amount of 0.2 μm, where the amplitude of the RF signal is largest, is an optimal value. The controller 7 then causes the offset addition circuit 8 to output the optimal focus offset value (step S19). Adjustment of the focus offset value is thus completed.

Further, similar operations are also performed when the vibration/flaw detection circuit 12 detects a flaw on the optical disk 1. For example, when a focus offset equivalent to a focus offset amount of −0.4 μm is applied to a focus error signal, similarly to the example described above, the detected value of the amplitude of the RF signal is erased, and processing shifts to the next step. The detected value of the amplitude of the RF signal corresponding to the offset value where a flaw was detected on the optical disk 1 is thus erased. Only the amplitude values of the RF signal corresponding to offset values where a flaw was not detected are stored successively in the amplitude value storage circuit 11. When detection of the amplitude values is then completed in a predetermined range, the focus offset value where the amplitude of the RF signal is the largest is calculated from the amplitude values where a flaw was not detected, and this focus offset value is set as an optimal focus offset value. The controller 7 causes the offset addition circuit 8 to output the. optimal focus offset value.

The optimal focus offset value can thus be calculated in the optical disk apparatus described above without the processing time required for adjusting the focus offset becoming long, even if vibrations are applied to the optical disk apparatus, or there is a flaw on the optical disk 1, during the focus offset adjustment. Further, even when there is a flaw on the optical disk 1, detection of the amplitude of the RF signal is interrupted only when the influence of the flaw is received, whereby it is not necessary to change the adjustment position.

Although processing of adjusting the focus offset value is explained here in this embodiment, this embodiment can also be applied to the adjustment of the optimal laser power for reproduction or recording, and to the adjustment of the amount of a spherical aberration correction amount. Furthermore, although detection of the size of a vibration and a flaw is performed here by referring to the focus error signal level, the sizes of the vibration and the flaw may also be detected by using a tracking error signal level or a lens position signal of an objective lens.

Further, although the focus offset value having the largest RF signal amplitude value is set as the optimal focus offset value in this embodiment in a method of deriving the optimal focus offset value, the optimal focus offset value may also be found by using jitters in a reproduction signal, bER (error rate), the amplitude of the tracking error signal, or the like as an evaluation index.

Second Embodiment

FIG. 5 is a block diagram that shows the second embodiment of the present invention. The blocks in FIG. 5 having the same function as those of FIG. 1 are denoted by the same reference numerals. First, focus control and tracking control are performed for a desired track on the optical disk 1 in this embodiment when electric power is turned on to the optical disk apparatus, when the optical disk 1 is exchanged, and the like, similarly to FIG. 1. Processing of adjusting the focus offset is then started, similarly to the first embodiment. In other words, the focus offset value is changed, for example, in a stepwise manner from −1 μm every 0.1 μm within a range of −1 μm to 1 μm. The RF signal amplitude detection circuit 10 detects values of the amplitude of the RF signal corresponding to the focus offset values, and the amplitude value storage circuit 11 stores the detected values.

The controller 7 refers to the stored RF signal amplitudes, and sets the focus offset value at which the maximum RF signal amplitude was detected as an optimal focus offset value so that the offset addition circuit 8 will output this focus offset value, thus performing adjustment of the focus offset value.

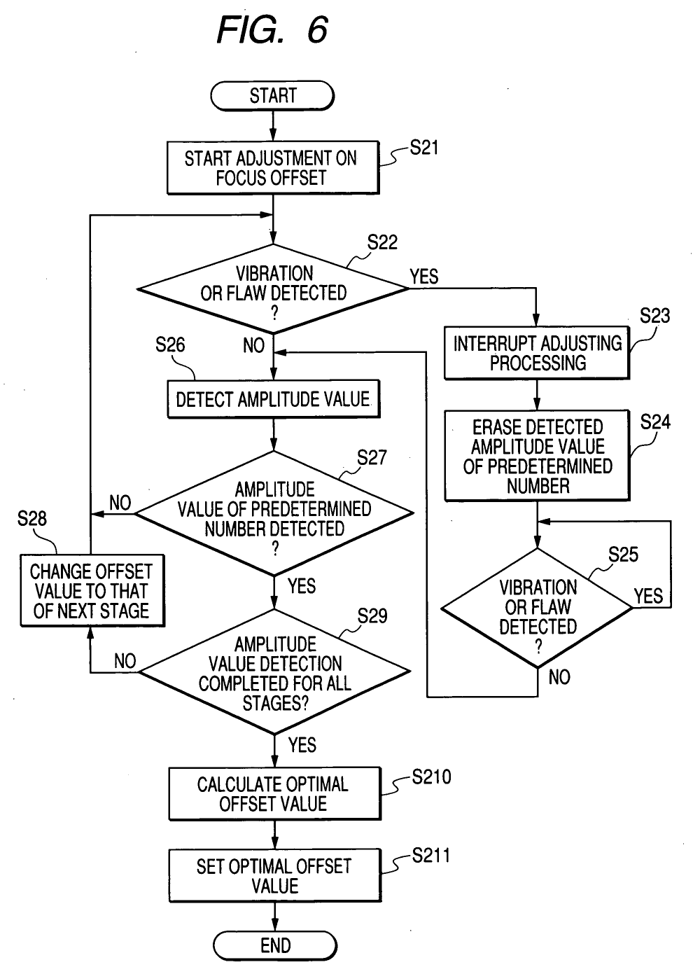

FIG. 6 is a flowchart that shows operations of this embodiment. In FIG. 6, first an offset initial value (−1 μm, for example) is set when focus offset adjustment is started, similarly to the first embodiment (step S21). Further, the vibration/flaw detection circuit 12 performs detection of vibration and flaws (step S22). In this case, a focus error signal is inputted to the vibration/flaw detection circuit 12, and a threshold value for the level of the focus error signal is set, similarly to the first embodiment. When the focus error signal exceeds the threshold value, it is determined that vibrations have been applied to the optical disk apparatus.

Detecting vibrations is performed here similarly to the first embodiment, and detection of flaws on the optical disk 1 is also similarly performed. When the vibration/flaw detection circuit 12 determines that vibrations have been applied to the optical disk apparatus, an adjustment interrupt signal is outputted to the amplitude value detection circuit 10 and to a sample number counting circuit 14 (step S23). The sample number counting circuit 14 is a circuit that counts the number of samples of the RF signal amplitude values.

When the adjustment interrupt signal is inputted, the amplitude value detection circuit 10 interrupts detection of the amplitude values of the RF signal, and the sample number counting circuit 14 notifies the controller 7 as to how many samples of the RF signal amplitude values were counted immediately before the point at which vibrations were detected. In this embodiment, one example of a method of determining the amplitude of the RF signal when the focus offset amount is 1 μm is to extract 100 samples of the amplitude value of the RF signal at a predetermined timing, and then to set the average value of the 100 samples (or an integrated value thereof) as the RF amplitude value for a focus offset amount of 1 μm.

In this detection method, when the number of samples of the RF signal taken at a point where it is determined that vibrations have been applied to the optical disk apparatus is for example 80, the sample number counting circuit 14 outputs the number 80 to the controller 7. The controller 7 immediately erases a predetermined number of sample values before the instant at which the number of samples is inputted, that is, the instant at which it was determined that vibrations have been applied to the optical disk apparatus (for example, 5 sample values before it was determined that vibrations have been applied) from the amplitude value storage circuit 11 (step S24). Next, when the adjustment interrupt signal is no longer outputted from the vibration/flaw detection circuit 12 (step S25), the amplitude value detection circuit 10 restarts detection of the RF signal amplitude (step S26). When the amplitude value storage circuit 11 stores a predetermined number of values (in the example described above, the 20 remaining values) (step S27), the controller 7 causes the offset addition circuit 8 to output the focus offset value of the next stage (step S28).

When vibrations are thus applied during adjustment of the focus offset, a predetermined number of the amplitude values of the RF signal before the vibrations were applied are thrown out. In addition, amplitude detection then continues until a predetermined number of samples of the amplitude value of the RF signal can be detected in a state where vibrations are not applied. When detection of the amplitude values of the RF signal corresponding to the focus offset values is completed for all stages by the method described above (step S29), the focus offset value when the amplitude value of the RF signal is largest is calculated (step S210). The controller 7 then sets the calculated value as an optimal focus offset value in the offset addition circuit 8 (step S211).

Effects of erasing a predetermined number of RF signal amplitude values before it is determined that vibrations have been applied are described next. First, when vibrations are applied to the optical disk apparatus during processing of adjusting the focus offset value similarly to the first embodiment, a focus error is presumed to change as shown in FIG. 7, similarly to the first embodiment. When vibrations are applied to the optical disk apparatus at a point t1 in FIG. 7, the vibration/flaw detection circuit 12 determines that vibrations have been applied to the optical disk apparatus at a point t2, that is, at the point where the focus error signal exceeds the threshold value FEth−.

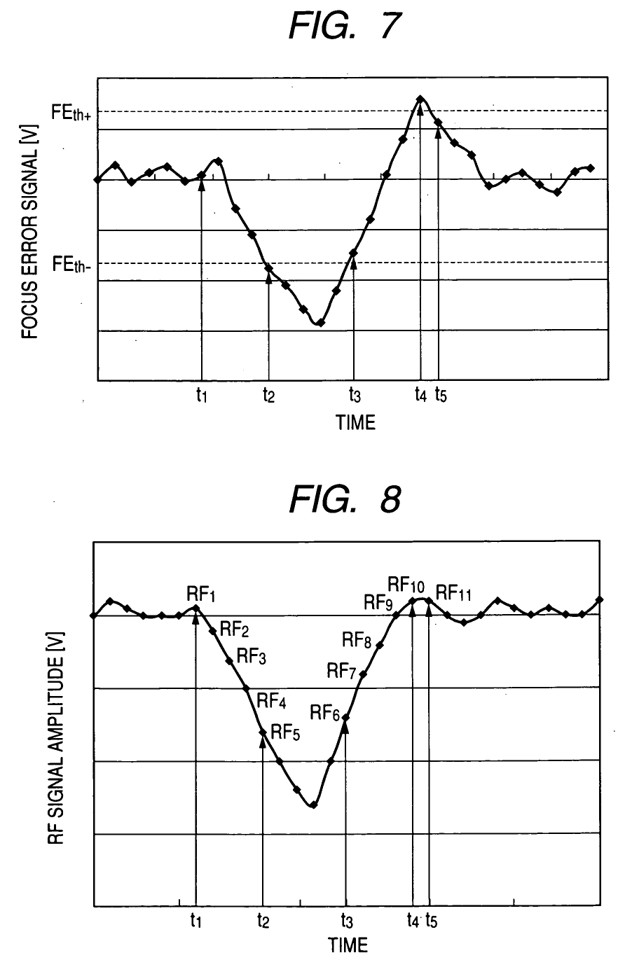

The amplitude of the RF signal also changes similarly as shown in FIG. 8 when vibrations are thus applied to the optical disk apparatus. The controller 7 can accurately detect the amplitude of the RF signal which is not influenced by vibrations by erasing the five detected values of the RF signal (RF1 to RF5), that is, the detected value of the RF signal at the point t2 and four detected values before the detected value at the point t2, from the amplitude value storage circuit 11 when it is determined that vibrations have been applied to the optical disk apparatus at the point t2. Further, the vibration/flaw detection circuit 12 then stops outputting the adjustment interrupt signal at the point t3. When the adjustment interrupt signal is no longer inputted, the amplitude value detection circuit 10 restarts detecting the amplitude value of the RF signal. In other words, the amplitude value storage circuit 11 restarts storing the amplitude values of the RF signal from an RF6 value in FIG. 8.

However, because the focus error signal level exceeds a threshold FEth+ at a point t4, the vibration/flaw detection circuit 12 again outputs the adjustment interrupt signal. The sample number counting circuit 14 receives the output adjustment interrupt signal and notifies the controller 7 of the number of samples of the amplitude values of the RF signal that have been detected. The controller 7 erases five sample values before the adjustment interrupt signal is outputted (values RF6 to RF10 in FIG. 8) from the amplitude value storage circuit 11.

The vibration/flaw detection circuit 12 then again stops outputting the adjustment interrupt signal at a point t5, and restarts RF signal amplitude detection (from a value RF11 in FIG. 8). Accurate RF signal amplitude values can always be detected by not adding a predetermined number of sample values at the point at which vibrations are detected and at the points before that point to detection of RF signal amplitude (by not adding the predetermined number of sample values to the calculation of the average value of the 100 sample values in the example described above), even in the case where the vibration/flaw detection circuit 12 determines that there is no influence from vibrations between the points t3 and t4, although the influence of vibrations actually remains.

The optimal focus offset value can thus always be detected by removing a predetermined number of RF signal amplitude values at the point at which the influence of vibrations or flaws is detected and at points before that point, in cases where vibrations are applied to the optical disk apparatus, or there is a flaw on the optical disk, during adjustment of the focus offset. Furthermore, accurate focus offset adjustment in a short period of time becomes possible, even for cases where the incidence of vibrations applied from outside is high. This can be achieved by disregarding the RF signal amplitude at the instant when the vibrations are applied, and by detecting a number of samples of the RF signal amplitude sufficient to calculate an average for the RF signal amplitude when vibrations are not applied.

In addition, although an example of processing of adjusting the focus offset value is explained in this embodiment, this embodiment can also be applied to the processing of adjustment of an optimal laser power for reproduction or recording, and to the processing of adjusting a spherical aberration correction amount. Further, although the detection of vibration size or the presence of flaws is performed in this embodiment by referring to the focus error signal level, the vibration size and the presence of flaws may also be detected by using a tracking error signal level or a lens position signal.

Furthermore, although setting the focus offset value having the largest RF signal amplitude value as the optimal focus offset value is used in this embodiment as a method of deriving the optimal focus offset value, the optimal focus offset value may also be found by using jitter in a reproduction signal, bER, the amplitude of the tracking error signal, or the like as an evaluation index.

Third Embodiment

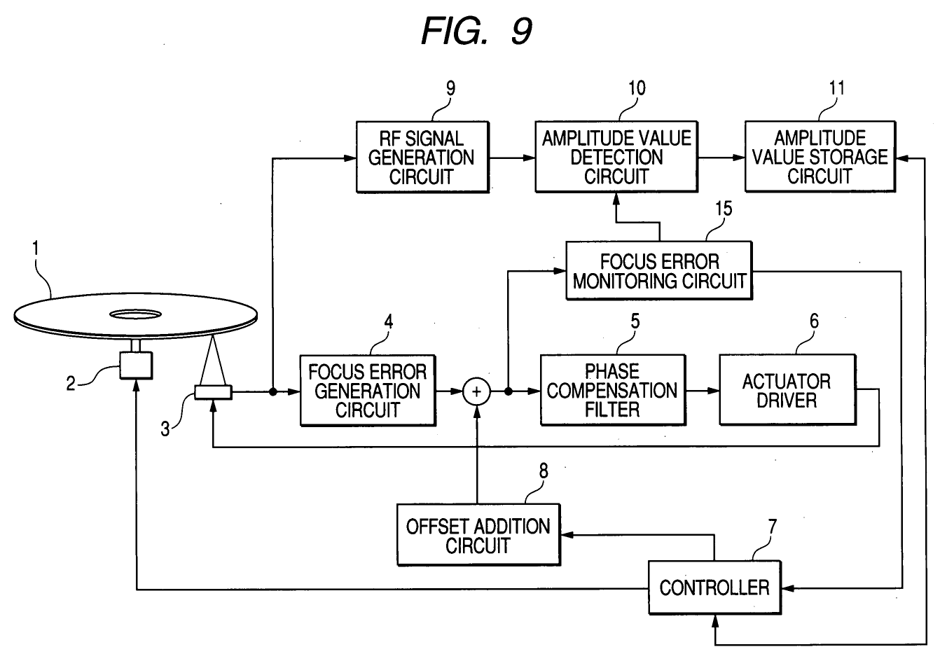

FIG. 9 is a block diagram that shows a constitution of the third embodiment of the present invention. The blocks in FIG. 9 having the same function as those of FIG. 1 are denoted by the same reference numerals. Only a focus error monitoring circuit 15 is a new function block. In this embodiment, first, focus control and tracking control are similarly performed for a desired track on the optical disk 1 in this embodiment when electric power is turned on to the optical disk apparatus, when the optical disk 1 is exchanged, and the like. Processing of adjusting the focus offset is then started, similarly to the first embodiment and the second embodiment.

In other words, the focus offset amount is changed in a stepwise manner, for example, from −1 μm every 0.1 μm within a range of −1 μm to 1 μm,. The amplitude value detection circuit 10 detects values of the amplitude of the RF signal corresponding to the focus offset values, and the amplitude value storage circuit 11 stores the detected values. The controller 7 refers to the stored RF signal amplitudes, and sets the focus offset value at which the maximum RF signal amplitude was detected as an optimal focus offset value so that the offset addition circuit 8 will output this focus offset value, thus performing adjustment of the focus offset value.

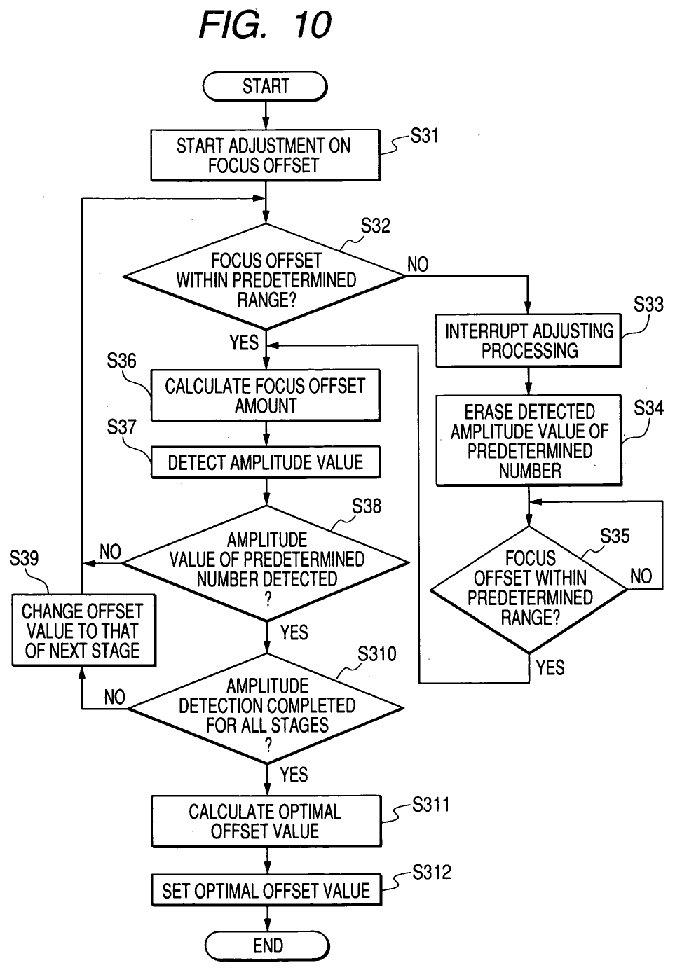

Operation of this embodiment is explained next with reference to the flowchart shown in FIG. 10. A focus error signal is inputted to the focus error monitoring circuit 15 during processing of adjusting the focus offset. When focus offset adjustment is started, the controller 7 sets an initial focus offset value (−1 μm, for example) through the offset addition circuit 8, similarly to the first embodiment and the second embodiment (step S31). Further, the focus error monitoring circuit 15 determines, from the focus error signal level, whether or not an actual focus error offset amount falls within a predetermined range (from −1 μm to 1 μm in the example described above) (step S32).

When the focus offset amount does not fall within the predetermined range, the focus error monitoring circuit 15 determines that the influence of vibrations or flaws has been received, and outputs an adjustment interrupt signal to the controller 7 (step S33). When the adjustment interrupt signal is inputted, the controller 7 erases a predetermined number of detected amplitude values at the instant at which the adjustment interrupt signal is inputted and before the instant, similarly to the second embodiment (step S34).

Next, a determination is made as to whether or not the focus offset amount is within the predetermined range (step S35). When the focus offset amount is within the predetermined range, the focus error monitoring circuit 15 calculates, from the focus error signal level, how much the actual focus offset amount is equivalent to (step S36).

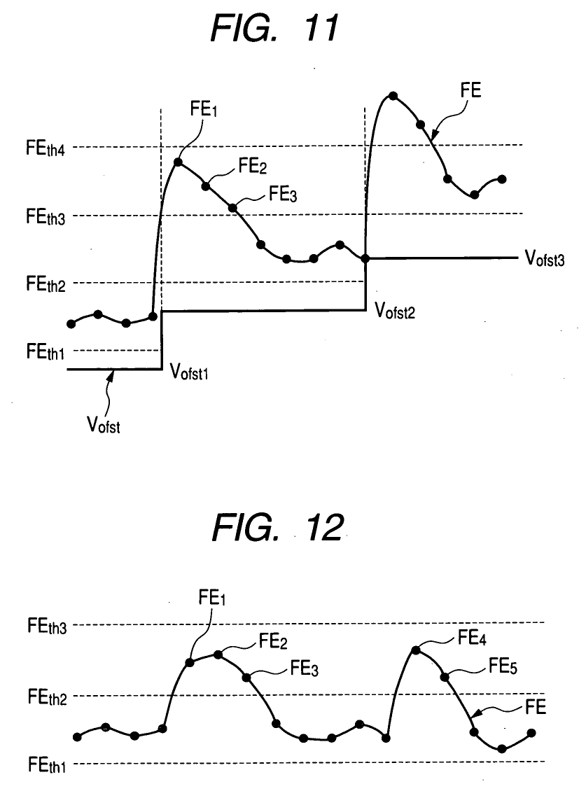

This method is explained with reference to FIG. 11, which shows changes in the focus error signal when the focus offset value is changed. Reference symbol Vofst in FIG. 11 denotes a focus offset value added to the focus error signal when processing of adjusting the focus offset is performed. When Vofst is Vofst1 in FIG. 11, the focus offset amount is assumed to be equivalent to −1 μm. In other words, when Vofst1 is added to the focus error signal, the amplitude value detection circuit 10 detects the RF signal amplitude when the focus offset is −1 μm.

When the size of Vofst is Vofst1, that is, when the value of the RF signal amplitude has been detected a predetermined number of times at the time of the focus offset of −1 μm, the controller 7 causes the offset addition circuit 8 to output the next focus offset value, for example, Vofst2 equivalent to the focus offset amount of −0.9 μm. When changes in the focus offset value are in a stepwise manner as shown in FIG. 11, a focus error FE possesses a peak at the point where the focus offset value changes.

When the focus error monitoring circuit 15 determines that the focus offset value is equivalent to −0.9 μm when the focus error signal level is between FEth2 and FEth3, and determines that the focus offset value is equivalent to −0.8 μm when the focus error signal level is between FEth3 and FEth4, the focus error monitoring circuit 15 determines that the focus offset amount when the focus error signal level is from FE1 to FE3 is not −0.9 μm, but rather the value of the next stage, −0.8 μm. The focus error monitoring circuit 15 notifies the controller 7 of this determination.

The amplitude of the RF signal when the focus error signal level is from FE1 to FE3, as the RF signal amplitude value when the focus offset amount is −0.8 μm, is stored in the amplitude value storage circuit 11 by the controller 7. The focus error signal level is thus monitored, the focus offset amount is accurately detected, and the controller 7 makes the amplitude value storage circuit 11 store the amplitude value as the RF signal amplitude value corresponding to the detected offset amount (step S37). Next, when the amplitude value corresponding to the currently applied offset value has been detected a predetermined number of times (step S38), the controller 7 causes the offset addition circuit 8 to output the offset value of the next stage (step S39).

When the amplitude values corresponding to the offset values of all stages are detected a predetermined number of times while the focus error signal level is monitored, accurate focus offset amounts are calculated, and the RF signal amplitude values are detected and stored (step S310), the focus offset value when the value of the amplitude of the RF signal is largest is calculated (step S311). The controller 7 sets the calculated value as an optimal focus offset value in the offset addition circuit 8 (step S312).

Optimal focus offset adjustment can be performed accurately and in the smallest amount of time necessary in this embodiment, without interrupting the adjustment processing unnecessarily, by calculating accurate focus offset values from the focus error signal levels.

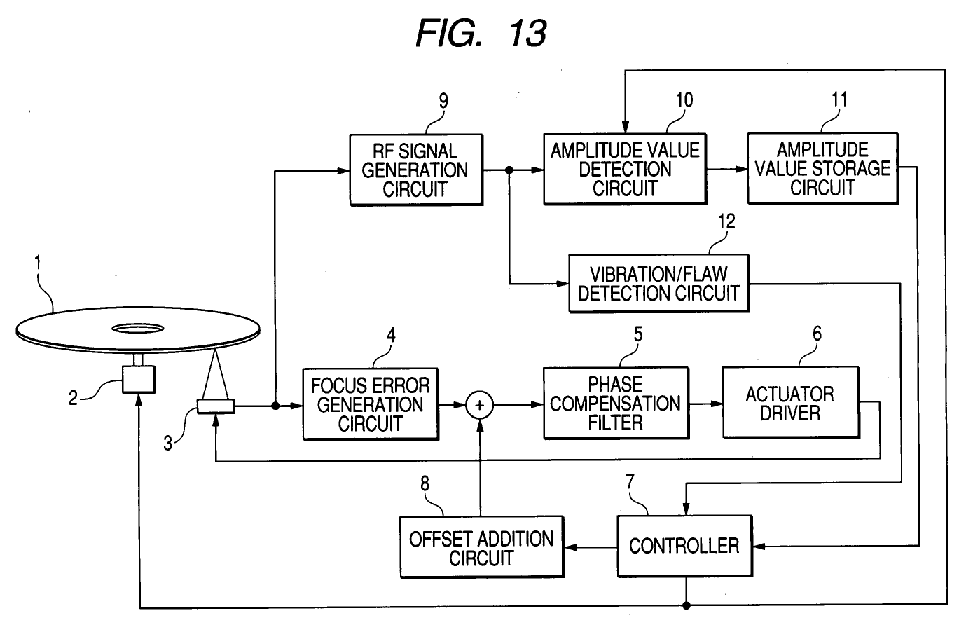

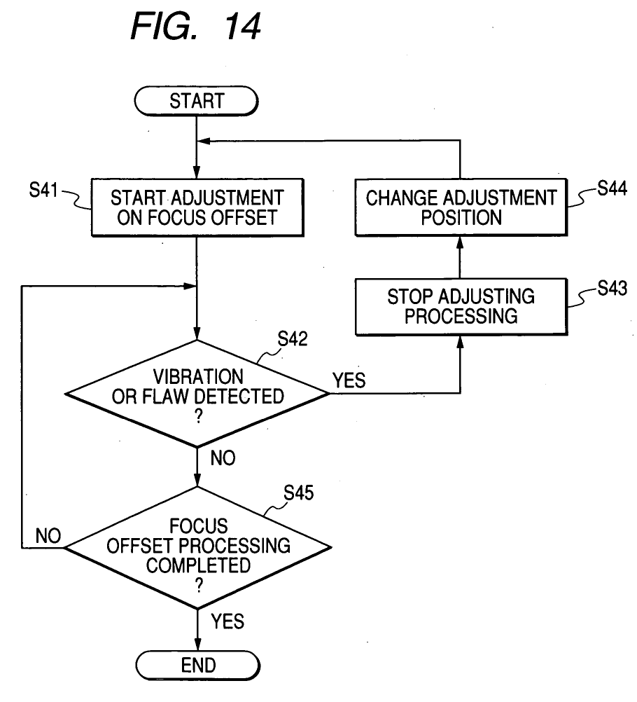

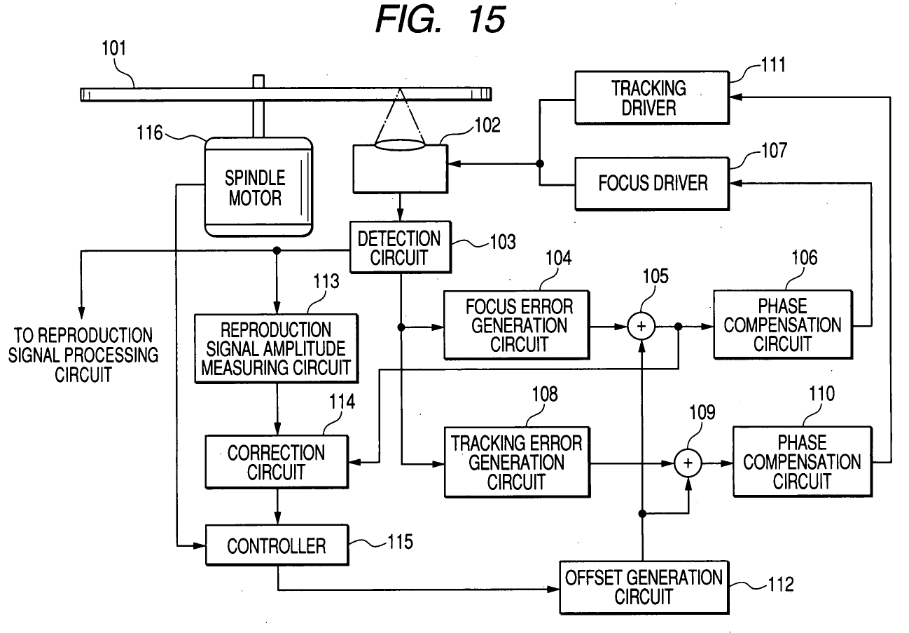

Furthermore, focus offset adjustment can be performed without receiving the influence of minute vibrations and the like that are not so large that the adjustment processing should be interrupted. For example, it is considered that the focus error signal changes as shown in FIG. 12 when minute vibrations are applied to the optical disk apparatus. When the offset value outputted by the offset addition circuit 8 is equivalent to a focus offset amount of −1 μm, and in addition, when the focus error signal level is in a range from FEth1 to FEth2, the focus error monitoring circuit 15 determines that the focus offset amount is equivalent to −1 μm.

However, when minute vibrations are applied to the optical disk apparatus, the focus error signal level exceeds a range from FEth1 to FEth2 as shown in FIG. 12. Points FE1 to FE3, FE4, and FE5 in FIG. 12 correspond thereto. The focus error monitoring circuit 15 makes the amplitude value storage circuit 11 store the RF signal amplitude when the focus offset value is −0.9 μm during FE1 to FE5, not −1 μm.

Thus, the focus error signal level is monitored, and the focus offset amount is always accurately monitored, whereby the influence of vibrations or flaws is not received, and there are no useless interruptions of the focus offset adjustment. Accordingly, the focus offset adjustment can be performed accurately and in the least possible amount of time. Further, vibrations are normally applied to the optical disk apparatus during use when the optical disk apparatus is a portable type apparatus such as a camcorder using an optical disk. In this case as well, the RF signal amplitudes corresponding to accurate focus offsets can be detected by monitoring the focus error signal level.

Further, although an example of processing of adjusting the focus offset value is explained in this embodiment, this embodiment can also be applied to the processing of adjusting an optimal laser power for reproduction or recording, and to the processing of adjusting a spherical aberration correction amount. In addition, although detection of the size of vibrations or the presence of flaws is performed by referring to the focus error signal level here, the detection of the size of vibrations or the presence of flaws may also be performed by using a tracking error signal level or a lens position signal.

In addition, although setting the focus offset value having the largest RF signal amplitude value as the optimal focus offset value is used in this embodiment as a method of deriving the optimal focus offset value, the optimal focus offset value may also be obtained by using metric jitter, bER, the amplitude of the tracking error signal, or the like as an evaluation index.

Fourth Embodiment

FIG. 15 is a block diagram that shows the fourth embodiment of an optical information recording and reproducing apparatus according to the present invention. In FIG. 15, reference numeral 101 denotes an optical disk, which is an information recording medium, and reference numeral 102 denotes an optical pickup unit that records and reproduces information by irradiating the optical disk 101 with an optical beam and detecting light reflected from the optical disk 101. The optical pickup unit 102 may be constituted by a semiconductor laser used as a light source, an objective lens that condenses a laser beam from the semiconductor laser onto the optical disk 101, an optical sensor that receives the light reflected from the optical disk 101, a focus actuator that drives the objective lens in a focus direction, a tracking actuator that drives the objective lens in a tracking direction, and the like.

Further, reference numeral 103 denotes a detection circuit that converts output from a plurality of light receiving elements constituting the optical sensor within the optical pickup unit 102 into an electric signal, and reference numeral 104 denotes a focus error generation circuit that generates a focus error signal from the signal outputted from the detection circuit 103. Reference numeral 105 denotes an offset addition circuit that applies an offset to a focus servo loop, and reference numeral 106 denotes a phase compensation circuit that performs phase compensation of the focus servo loop. Reference numeral 107 denotes a focus driver that drives the focus actuator within the optical pickup unit 102.

In addition, reference numeral 108 denotes a tracking error generation circuit that generates a tracking error signal based on the output of the detection circuit 103, reference numeral 109 denotes an offset addition circuit 109 that applies an offset within a tracking servo loop, and reference numeral 110 denotes a phase compensation circuit that performs phase compensation of the tracking servo loop. Reference numeral 111 denotes a tracking driver that drives the tracking actuator within the optical pickup unit 102. Reference numeral 112 denotes an offset generation circuit that generates an offset that is applied to the focus servo loop and to the tracking servo loop, and reference numeral 113 denotes a reproduction signal amplitude measuring circuit 113 that measures the amplitude of a signal outputted from the detection circuit 103 (reproduction signal), that is, the amplitude of a reproduction signal that is reproduced from the optical disk 101. Reference numeral 114 denotes a correction circuit, reference numeral 115 denotes a controller that controls various parts, and reference numeral 116 denotes a spindle motor that rotatably drives the optical disk 101.

The optical disk 101 is fixed to the spindle motor 116, and driven at a predetermined rotation speed. Laser light emitted from the semiconductor laser (not shown) within the optical pickup unit 102 is condensed onto the optical disk 101 by the objective lens. Reflected light that is reflected from the optical disk 101 is received by the optical sensor constituted by the plurality of light receiving elements, via the objective lens and the like within the optical pickup unit 102.

The outputs of the plurality of light receiving elements constituting the optical sensor are converted into electrical signals by the detection circuit 103, and inputted to the focus error generation circuit 104 and to the tracking error generation circuit 108. A focus error signal is generated by performing predetermined arithmetic processing on the plurality of electrical signals from the detection circuit 103 in the focus error generation circuit 104. A tracking error signal is similarly generated by predetermined arithmetic processing within the tracking error generation circuit 108. The term predetermined arithmetic processing means, for example, finding the difference in the sums of the diagonal angles of the light receiving elements divided into four portions according to an astigmatism method for focusing, and finding the difference in the sums in a tracking direction of the light receiving elements divided into four portions according to a push-pull method for tracking, and the like. Any method may be used for detecting the error signals.

Further, the output signal (reproduction signal) from the detection circuit 103 is inputted to a reproduction signal processing circuit (not shown), and the reproduction signal processing circuit performs reproduction processing of information recorded onto the optical disk 101. Furthermore, the reproduction signal is inputted to the reproduction signal amplitude measuring circuit 113, which performs measurement of the reproduction signal amplitude as described above.

The offset addition circuit 105 adds a predetermined offset to the focus error signal outputted by the focus error generation circuit 104, and the result is inputted to the phase compensation circuit 106. The focus error signal to which the predetermined offset has been added is then also inputted to the correction circuit 114. A signal that has undergone phase compensation by the phase compensation circuit 106 is inputted to the focus driver 107, driving the focus actuator within the optical pickup unit 102, and performing focus servo control. An optical spot focus is thus aligned to an information surface of the optical disk 101.

On the other hand, the offset addition circuit 109 adds a predetermined offset to the tracking error signal outputted by the tracking error generation circuit 108, and the result is inputted to the phase compensation circuit 110. A signal that has undergone phase compensation by the phase compensation circuit 110 is then inputted to the tracking driver 111, driving the tracking actuator (not shown) within the optical pickup unit 102, and performing tracking servo control. The optical spot is thus made to track an information track on the optical disk 1.

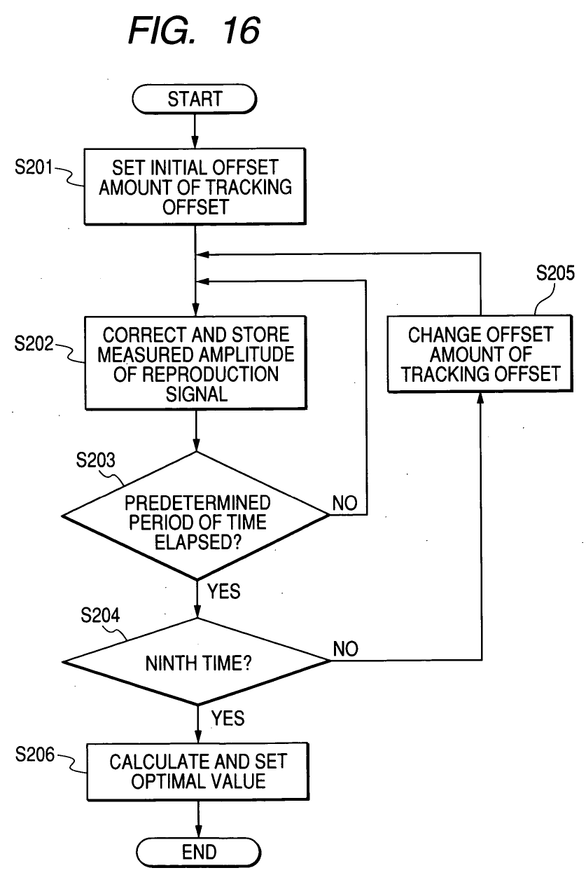

A method of adjusting an optimal tracking offset according to this embodiment is explained next with reference to the flowchart of FIG. 16. The term adjusting the optimal tracking offset means performing focus control and tracking control in a state similar to the normal mode described above on an adjustment track on which a predetermined signal is recorded in advance.

Before adjustment is performed, optimal focus offset adjustment is taken as being completed, and the offset generation circuit 112 supplies a focus offset adjustment value to the offset addition circuit 105. Before adjustment, the value added is zero.

The controller 115 begins adjustment operations in synchronous with a rotation synchronization signal from the spindle motor 116. First, an initial tracking offset amount is given by the offset generation circuit 112 (step S201). The offset generation circuit 112 can give different offsets for tracking and for focusing. The focus offset amount is fixed to a predetermined value at time other than during focus offset control, including adjusting the tracking offset. The focus offset amount is an adjusted value because adjustment has already been completed. Next, output from the reproduction signal amplitude measuring circuit 113 is integrated in a memory (not shown) within the controller 115, via the correction circuit 114, for a fixed period of time (steps S202 and S203). A correction method used by the correction circuit 114 is described later.

The fixed period of time is set to a period of time on the order of one-tenth of one rotation of the spindle motor 116 so that offset processing can be performed within one rotation. For example, when the rotation speed of the spindle motor 116 is 25 Hz, one rotation takes 40 msec, and the fixed period of time is set on the order of 4 ms. This value may be appropriately set based on items to be adjusted. For the tracking offset adjustment of this embodiment, a period of time on the order of one-tenth of one rotation is chosen in consideration of the servo response time after the offset is changed.

The reproduction signal amplitude measuring circuit 113 measures and outputs the amplitude of the reproduction signal at predetermined periods of time. For example, the amplitude can be detected by applying the reproduction signal to a peak hold circuit (not shown) and a bottom hold circuit (not shown). The predetermined period is suitably determined as a period longer than the signal frequency recorded on the adjustment track of the optical disk 101. For example, when a signal on the order of 10 MHz is recorded on the adjustment track, it is possible to measure the amplitude provided that the predetermined period has a length of 0.1 μs or longer. For example, with a period of 1 μs and an offset first stage on the order of 4 ms, it becomes possible to integrate 4,000 points.

Next, the controller 115 determines whether or not ninth processing has been completed (step S204), and changes the tracking offset amount if ninth processing has not been completed (step S205). Processing then returns to step S202. Similar processing is repeatedly performed after the offset amount is changed, and is completed when the ninth processing has been completed in step S204. The offset amount is set here to a suitable range in consideration of the adjustment range, and is divided into 8 equivalent portions from the minimum value to the maximum value centered about electrical zero. For example, the offset amount is set to a range from −0.04 μm to 0.04 μm in steps of 0.01 μm.

Next, the controller 115 detects the offset amount having the largest reproduction amplitude from the nine sets of integrated data, and sets this value into the offset generation circuit 112, thus completing adjustment processing (step S206).

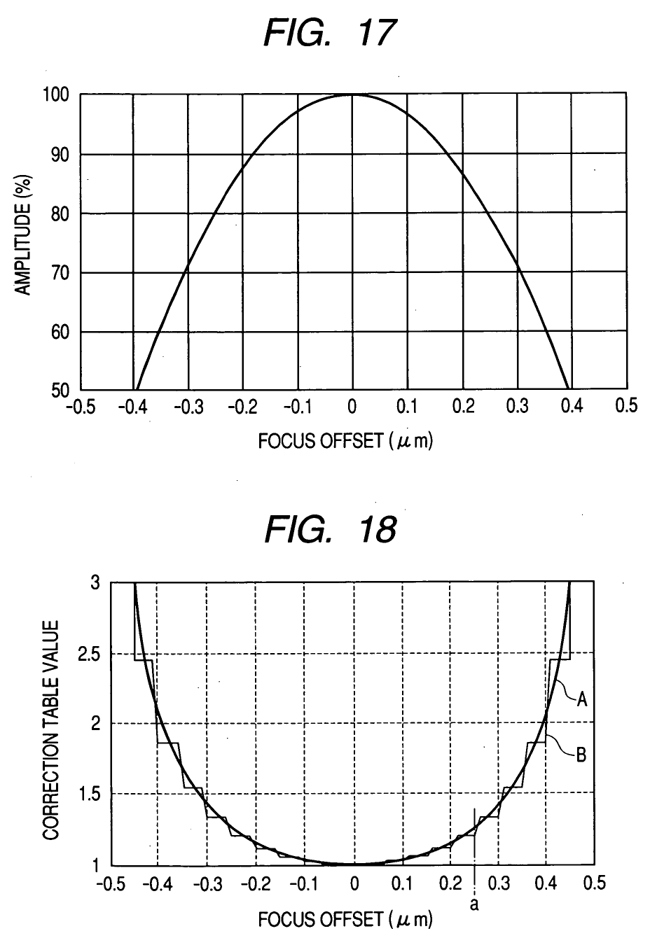

A correcting method used by the correction circuit 114 is explained next. FIG. 17 shows a standard relationship between focus offset and a reproduction signal amplitude when the focus point is moved with an optimal focus point taken as zero. As is clear from FIG. 17, the amplitude is largest at the focus offset zero point, and the amplitude becomes smaller with increasing offset, regardless of the offset polarity.

A curve A of FIG. 18 shows the inverse of the reproduction signal amplitude having those characteristics. By making a table out of the inverse of the reproduction signal amplitudes as in the curve A of FIG. 18, and multiplying by the reproduction signal amplitude measured according to the focus offset amount, it is possible to correct measurement errors due to focus offset. It should be noted that, although the horizontal axis of FIG. 18 indicated the focus offset amount, the focus offset amount may also be thought of as the same as the size of the focus error signal.

For example, when the focus error, which is the output of the focus addition circuit 105, is zero, the reproduction amplitude is multiplied by 1 and stored in the controller 115 as it is. When the focus error is +0.25 μm (point a in FIG. 18), the value from the table becomes approximately 1.25, and the reproduction amplitude is multiplied by 1.25 and stored in the controller 115.

The correction circuit 114 multiplies the reproduction signal amplitude outputted from the reproduction signal amplitude measuring circuit 113 at the predetermined period by a table value corresponding to the value of the focus error at that point, and outputs the result to the controller 115. For example, when there are 4,000 points of amplitude data within an amplitude read-in period of 4 msec at the predetermined tracking offset, the values at each point are multiplied by the table value for the focus offset, and integrated in the controller 115.

That is, the reproduction amplitude values integrated by the controller 115 within the fixed period of time are corrected by the value of the focus error signal at the specific time of the individual reproduction amplitude values. Even if there are increases in focus deviation due to external disturbances such as vibrations, that is, even if the values temporarily do not show their original values due to focus offset. Accordingly, it becomes possible to minimize the influence of vibrations and the like.

Although a detailed correction table is made from the curve A of FIG. 18 in this embodiment, the correction table may also be divided into predetermined focus error ranges, and stepwise tables may be used so that the same correction value can be used for all focus errors within a certain range. Reference symbol B of FIG. 18 is one example of a correction table that uses ranges, and shows a case where a correction table is set up in a stepwise manner with average value every 0.05 μm is used as a table value. In this case, the number of tables can be reduced, and it becomes possible to simplify the circuitry.

Further, only values every 0.05 μm may be plotted, and values between the plotted values may be obtained by linear interpolation. In addition, a relationship between the size of the error signal and the correction amount may be approximated with a function, so correction amounts may be found by computation, without using a correction table.

In addition, although a standard table is used in this embodiment as the correction table, for cases where, prior to the tracking offset adjustment, the focus offset adjustment is performed by using procedures that are similar to those used in the tracking offset adjustment, a relationship similar to that shown in FIG. 17 can be measured by setting the horizontal axis in the figure to the focus offset from the nine sets of integrated data, and the vertical axis to the reproduction amplitude. The inverse of the measured data may also be used as the correction table. In this case, the optical disk 101 and the optical pickup unit 102 actually employed are used, and the correction accuracy can be thus improved.

Further, during adjustment processes in a factory before delivery, the offset may be changed and the reproduction amplitude may be measured by using a standard disk, and inverse table values based on the measured values may be stored on an EEPROM or the like, and the stored values may be used in correction. A relationship between servo offset and an amplitude is influenced more greatly by differences in the optical pickup unit than by differences in the optical disk. Accordingly, by creating an inverse table for each optical pickup unit at the time of delivery from the factory, correction in consideration of the differences in the optical pickup units becomes possible. Correction that is more accurate than the method using the standard table can thus be achieved.

In addition, the focus error signal used by the correction circuit 114 may have the same period as the period of the reproduction signal amplitude measurement (1 μs in this embodiment), and may also use a longer period in which the influence of external disturbances such as vibrations can be detected, and then take an average over the period. In this case, it becomes possible to perform correction with improved accuracy without the influence of noise and the like.

Further, although correction of the reproduction signal amplitude is performed in this embodiment according to the size of the focus error signal during tracking offset adjustment, this embodiment is not limited to this method. The correction may be performed according to the size of the tracking error signal that becomes a factor for correction, the size of a lens position signal of the objective lens, the size of a spherical aberration correction signal, and the like. Any signal may be used, provided that it is an error signal that can be a horizontal axis of a table or on a function related to the reproduction signal amplitude.

Further, although the reproduction signal amplitude is used as a reproduction index in this embodiment as means of evaluating the signal quality, any index that changes according to the size of the servo error signal such as a jitter value or an error rate can also be used.

In addition, items to be adjusted are not limited to the tracking offset. Other items can also be adjusted, provided that they are items that are adjusted using the signal quality as a reproduction index, such as all types of servo offsets, a spherical aberration correction amount, reproduction power, and equalization filter. The adjustment of the spherical aberration correction amount, the adjustment of the reproduction power, and equalization filter adjustment are described in separate embodiments.

Further, although the size of the focus error signal is regarded as an item to correct the influence of external disturbances, the size of the tracking error signal may also be observed, and both correction methods may be performed at the same time. In this case, it becomes possible to minimize the influence of external disturbances on both focus and tracking.

Furthermore, correction according to other correction items such as a lens position may also be performed at the same time. In addition, changes in the spherical aberration of the spot on the medium that are generated by changes in the transmission substrate thickness of the disk may be detected, and the amplitude value of the reproduction signal can be corrected by the detected values of the spherical aberration.

According to this embodiment, a reproduction signal amplitude value corrected by the correction table is used during operations of adjusting the tracking offset, and it therefore becomes possible to minimize the influence of external disturbances such as vibrations, even when the focus error becomes large for an instant due to the external factors such as vibrations. Further, it becomes possible to complete the adjustment within a fixed period of time because adjustment is not restarted from the beginning due to vibrations. In addition, index detection is even possible even under continuous vibrations. Accordingly, the adjustment always converges.

Fifth Embodiment

The fifth embodiment of the present invention is explained next. In the fourth embodiment, the influence of external disturbances such as vibrations on focusing during tracking offset adjustment is suppressed, while in this embodiment, the influence of external disturbances on focusing during focus offset adjustment is suppressed. The constitution and normal operation of the fifth embodiment are similar to those of the fourth embodiment.

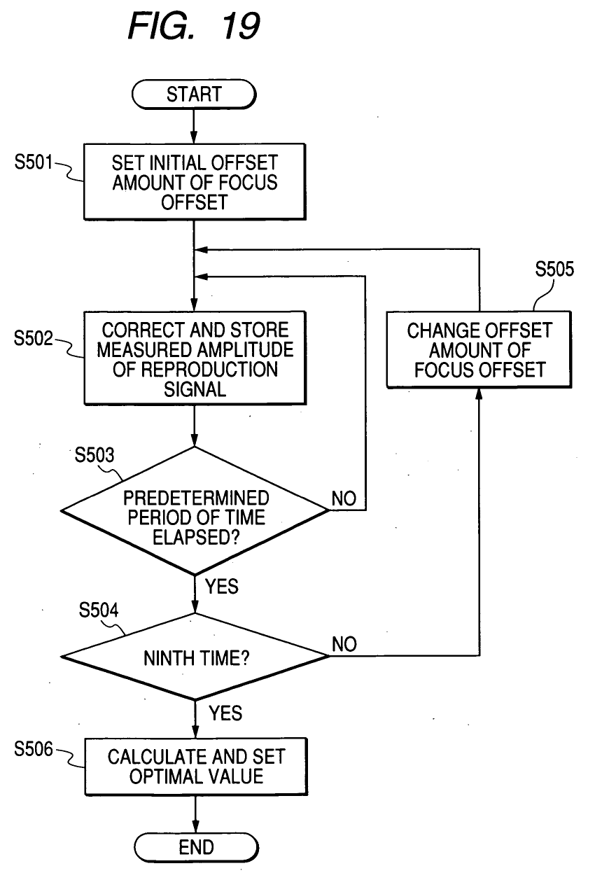

A method of adjusting the optimal focus offset is explained next, together with the flowchart of FIG. 19. Optimal focus offset adjustment is performed similarly to tracking offset, on an adjustment use track on which a predetermined signal has been recorded in advance, in a state where normal focus control and tracking control are employed similarly to the normal mode. The controller 115 starts adjustment operations in synchronous with a rotation synchronization signal from the spindle motor 116. First, the offset generation circuit 112 is provided with an initial focus offset amount (step S501). The focus offset amount is zero because it has not been adjusted yet. Next, output from the reproduction signal amplitude measuring circuit 113 is integrated in the memory within the controller 115, via the correction circuit 114, for a fixed period of time (steps S502 and S503). Subsequent processing is performed similarly to that of the fourth embodiment, except that focus offset for tracking offset.

The controller 115 repeatedly performs similar operations 9 times while changing the offset amount, until processing has been completed (steps S504 and S505). The focus offset amount is set to a suitable range in consideration of the adjustment range, and is divided into eight equivalent portions with the minimum value and the maximum value centered about electrical zero. For example, the focus offset amount is set from −0.4 μm to 0.4 μm in steps of 0.1 μm.

Next, the controller 115 detects the offset amount where the reproduction amplitude becomes largest from among the nine sets of integrated data, and sets the offset amount in the offset generation circuit 112, thus completing adjustment processing (step S506).

The correction circuit 114 is explained next. The focus offset is adjusted here unlike the fourth embodiment, and the optimal focus position is thus not yet known. The zero point and the optimal point in the correction table do not match with each other. In this embodiment, rough measurement of the amplitude of the reproduction signal is made according to two offset values that differ greatly by ±0.15 μm before fine measurements. A near zero point is found from the rough measurements and from a standard table (or from a standard function), and corrections are applied with that point taken as the zero point in the table. Although an excess amount of time is required for the rough adjustment portion, the accuracy of corrections during vibrations increases. Subsequent processes are the same as those of the fourth embodiment.

The amplitude values are thus corrected according to the focus error signal value at that time, even if the reproduction amplitude value integrated by the controller 115 within a fixed period of time temporarily does not show its original value due to a focus offset caused by external disturbances such as vibrations. Accordingly, it becomes possible to minimize the influence of vibrations in this embodiment as well.

Further, during adjustment processes in a factory before delivery, the offset may be changed and the reproduction amplitude may be measured by using a standard disk, and the optimal offset value based on the measured reproduction amplitude values may be stored in an EEPROM or the like. The stored optimal offset value may be used as the zero point of the table.

The optimal value of the focus offset is influenced more greatly by differences in the optical pickup unit than by differences in optical disks. Accordingly, accurate correction can be performed, and excessive time becomes unnecessary, by storing the optimal focus offset value at the time of delivery from the factory, even if the operations of finding the zero point by rough measurement are omitted.

In addition, during the adjustment processes in the factory before delivery, the offset may be changed and the reproduction amplitude may be measured by using a standard disk, and inverse table values based on the measured reproduction amplitude values may be stored in an EEPROM or the like. The stored inverse table values may also be used after delivery.

A relationship between servo offset and amplitude is influenced more greatly by differences in the optical pickup unit than by differences in the optical disk. Accordingly, by creating an inverse table for each optical pickup unit at the time of delivery from the factory, correction in consideration of the differences in the optical pickup units becomes possible. Correction that is more accurate than the method using the standard table can thus be achieved. Further, it becomes possible to complete the adjustment within a fixed period of time because adjustment is not restarted from the beginning due to vibrations.

In addition, although correction of the reproduction signal amplitude is performed in this embodiment according to the size of the focus error signal during focus offset adjustment, this embodiment is not limited to this method. The offset amount to be adjusted, and the error signal that becomes a factor for correction may also use the size of the tracking error signal, the size of a lens position signal of the objective lens, and the like. Any signal may be used, provided that it is an error signal that can be used to make a table or a function related to the reproduction signal amplitude.

Further, although the reproduction signal amplitude is used as a reproduction index in this embodiment as means of evaluating the signal quality, any index that changes according to the size of the servo error signal, such as a jitter value or an error rate may also be used. Furthermore, although the size of the focus error signal is regarded as an item to correct the influence of external disturbances, the size of the tracking error signal may also be observed, and both correction methods may be performed at the same time. In this case, it becomes possible to minimize the influence of external disturbances on both focus and tracking.

Furthermore, correction of other correction items, for example, correction according to the position of the objective lens, may also be performed at the same time.

According to this embodiment, a reproduction signal amplitude value corrected by the correction table is used during operations of adjusting the focus offset, and it therefore becomes possible to minimize the influence of external disturbances such as vibrations, even when the focus error becomes large for an instant due to the external disturbances such as vibrations. Further, it becomes possible to complete the adjustment within a fixed period of time because adjustment is not restarted from the beginning due to vibrations. In addition, index detection is even possible even under continuous vibrations. Accordingly, the adjustment always converges.

Sixth Embodiment

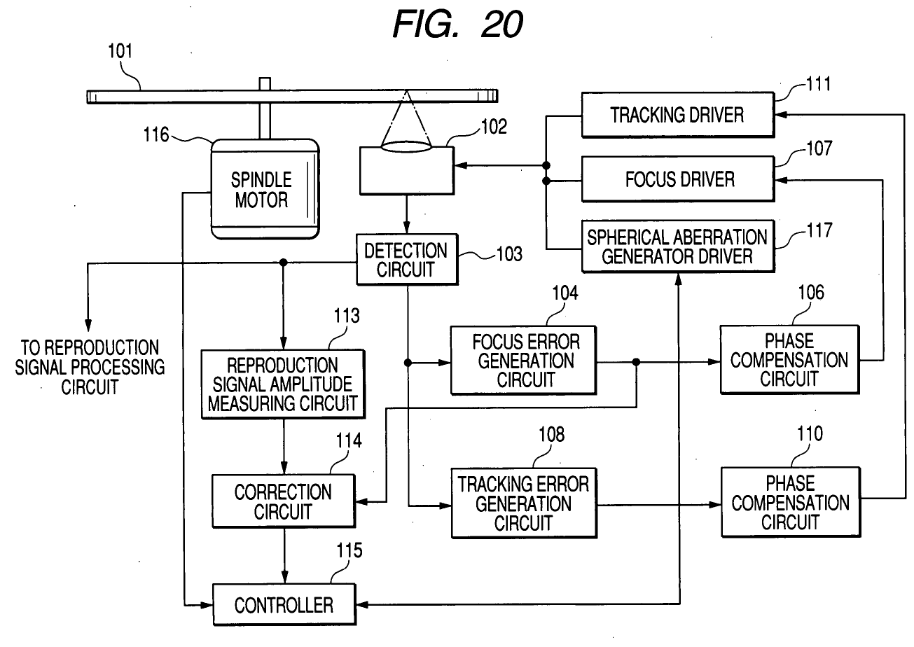

The sixth embodiment of the present invention is explained next. FIG. 20 is a block diagram that shows the constitution of this embodiment. The parts of FIG. 20 which are the same as those of FIG. 15 are denoted by the same reference numerals of FIG. 15, and description thereof are omitted. A spherical aberration generator driver 117 is added here unlike the configuration of FIG. 15. A device disclosed by Japanese Patent Application Laid-Open No. H10-106012 may be used as a spherical aberration amount generator, for example. The device generates a spherical aberration by moving a coupling lens that is disposed between the objective lens and the semiconductor laser.

The spherical aberration generator driver 117 drives a stepping motor connected to the coupling lens (not shown) within the optical pickup unit 102 by instructions from the controller 115.

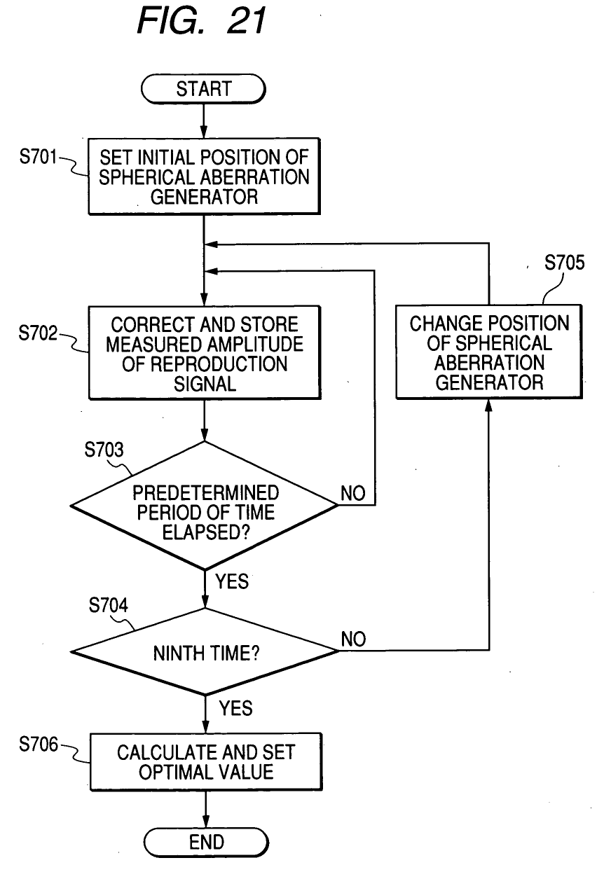

Adjustment of the spherical aberration amount of this embodiment is explained next with reference to the flowchart of FIG. 21. Adjustment of an optimal spherical aberration amount is performed by performing focus control and tracking control in a state similar to the normal mode on an adjustment track on which a predetermined signal has been recorded in advance, similarly to the fourth embodiment and the fifth embodiment.

The controller 115 starts adjustment operations in synchronous with a rotation synchronization signal from the spindle motor 116. First, an instruction is given to the spherical aberration generator driver 117, and the position of the coupling lens is set at an initial position (step S701). Next, output from the reproduction signal amplitude measuring circuit 113 is integrated in the memory within the controller 115, via the correction circuit 114, for a fixed period of time (steps S702 and S703). The controller 115 then changes the instruction to the spherical aberration generator driver 117 by a predetermined amount, and repeatedly performs similar operations 9 times, before finish (steps S704 and S705).

The amount instructed to the spherical aberration generator driver 117 is set in a suitable range in consideration of the adjustment range of the optical system, and is divided into eight equivalent portions with the minimum value and the maximum value centered about a designed optimal point. Next, the controller 115 detects the spherical aberration position at which the reproduction amplitude is the largest from among the nine sets of integrated data, and sets the detected value in the spherical aberration generator driver 117. Adjustment processing is thus completed (step S706).

The correction circuit 114 multiples the reproduction signal amplitude outputted from the reproduction signal amplitude measuring circuit 113 for the fixed period by a table value corresponding to the focus error value at the time when the reproduction signal amplitude was measured, and outputs the result to the controller 115. Operation of the correction circuit 114 is the same as that of the fourth embodiment.

Further, a relationship between the focus offset amount and the reproduction signal amplitude can also be measured in this embodiment when focus offset adjustment is performed before adjustment of the spherical aberration amount, and a correction table can also be made using this data. In this case, the optical disk and the optical pickup unit actually employed are used, and correction accuracy can therefore be improved.

Further, during adjustment processes in a factory before delivery, the offset may be changed and the reproduction amplitude may be measured by using a standard disk, and inverse table values based on the measured reproduction amplitude values may be stored in an EEPROM or the like and used. In this case, the relationship between the servo offset and the amplitude is influenced more greatly by differences in the optical pickup than by differences in optical disks. Accordingly, it becomes possible to perform correction in consideration of differences in the optical pickup that is more accurate than that of a method using a standard table, and correction can be performed with improved accuracy.

Furthermore, in this embodiment, although the size of the focus error signal is regarded as an item to correct the influence of external disturbances, the size of the tracking error signal may also be observed, and both correction methods may be performed at the same time. In this case, it becomes possible to minimize the influence of external disturbances on both focus and tracking.

Further, correction according to other correction items such as the position of the objective lens may also be performed at the same time.

According to this embodiment, a reproduction signal amplitude value corrected by the correction table is used during operations of adjusting the spherical aberration amount, and it therefore becomes possible to minimize the influence of external disturbances such as vibrations, even when the focus error becomes large for an instant due to the external disturbances such as vibrations. Further, it becomes possible to complete the adjustment within a fixed period of time because adjustment is not restarted from the beginning due to vibrations. In addition, index detection is even possible even under continuous vibrations. Accordingly, the adjustment always converges.

Seventh Embodiment

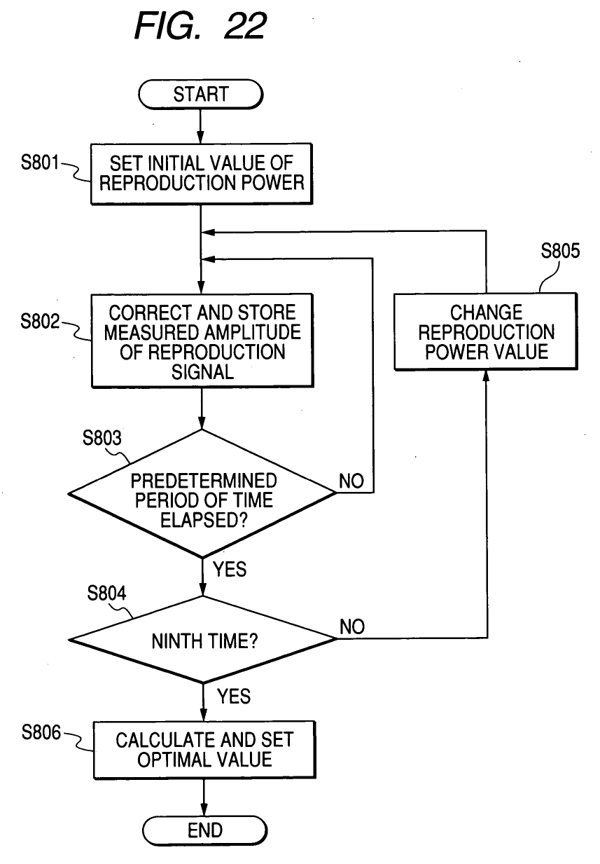

The seventh embodiment of the present invention is explained next. The constitution of the seventh embodiment is similar to that shown in FIG. 15, and reproduction power adjustment is explained in this embodiment with reference to FIG. 15 and FIG. 22. Adjustment of reproduction power is performed by performing focus control and tracking control in a state similar to the normal mode on an adjustment track on which a predetermined signal has been recorded in advance, similarly to the fourth embodiment.

First, the controller 115 starts adjustment operations in synchronous with a rotation synchronization signal from the spindle motor 116. That is, an instruction is given to a laser control circuit (not shown) and the power of the semiconductor laser within the optical pickup unit 102 is set to an initial value (step S801 of FIG. 22). Next, output from the reproduction signal amplitude measuring circuit 113 is integrated in the memory within the controller 115, via the correction circuit 114, for a fixed period of time (steps S802 and S803). The controller 115 then changes the instruction to the laser control circuit by a predetermined amount and repeatedly performs similar operations 9 times before finish (steps S804 and S805).

The amount instructed to the laser control circuit is set within a suitable range in consideration of the adjustment range, and is divided into eight equivalent portions with the minimum value and the maximum value centered about the designed optimal point. The controller 115 detects the reproduction power at which the reproduction amplitude is largest from among the nine sets of integrated data, and sets the detected value in the laser control circuit. Adjustment processing is thus completed (step S806).

The correction circuit 114 multiples the reproduction signal amplitude outputted from the reproduction signal amplitude measuring circuit 113 for the fixed period by a table value corresponding to the focus error value at the time when the reproduction signal amplitude was measured, and outputs the result to the controller 115. Operation of the correction circuit 114 is the same as that of the first embodiment.

Further, a relationship between the focus offset amount and the reproduction signal amplitude can also be measured in this embodiment when focus offset adjustment is performed before adjustment of the reproduction power, and a correction table can also be made using this data. In this case, the optical disk and the optical pickup unit actually employed are used, and correction accuracy can therefore be improved.

Further, during adjustment processes in a factory before delivery, the offset may be changed and the reproduction amplitude may be measured by using a standard disk, and inverse table value based on the measured reproduction amplitude values may be stored in an EEPROM or the like and used. In this case, the relationship between the servo offset and the amplitude is influenced more greatly by differences in the optical pickup than by differences in optical disks. Accordingly, it becomes possible to perform correction in consideration of differences in the optical pickup that is more accurate than that of a method using a standard table, and very accurate correction can be performed.

Furthermore, although the size of the focus error signal is regarded as an item to correct the influence of external disturbances, the size of the tracking error signal may also be observed, and both correction methods may be performed at the same time. In this case, it becomes possible to minimize the influence of external disturbances on both focus and tracking.

Further, correction according to other correction items such as the position of the objective lens may also be performed at the same time.

According to this embodiment, a reproduction signal amplitude value corrected by the correction table is used during operations of adjusting the reproduction power, and it therefore becomes possible to minimize the influence of external disturbances such as vibrations, even when the focus error becomes large for an instant due to the external disturbances such as vibrations. Further, it becomes possible to complete the adjustment within a fixed period of time because adjustment is not restarted from the beginning due to vibrations. In addition, index detection is even possible even under continuous vibrations. Accordingly, the adjustment always converges.

Eighth Embodiment

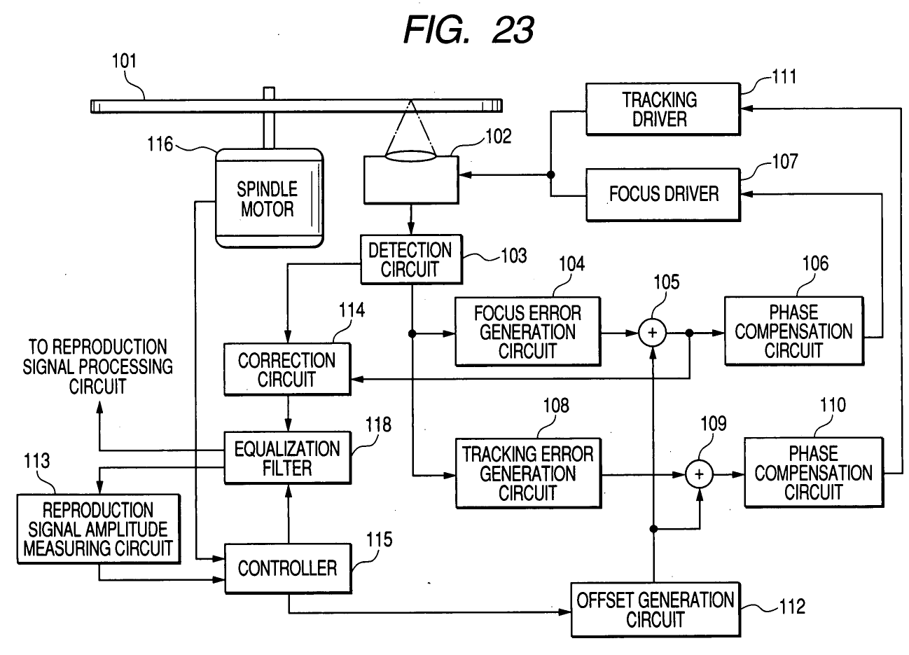

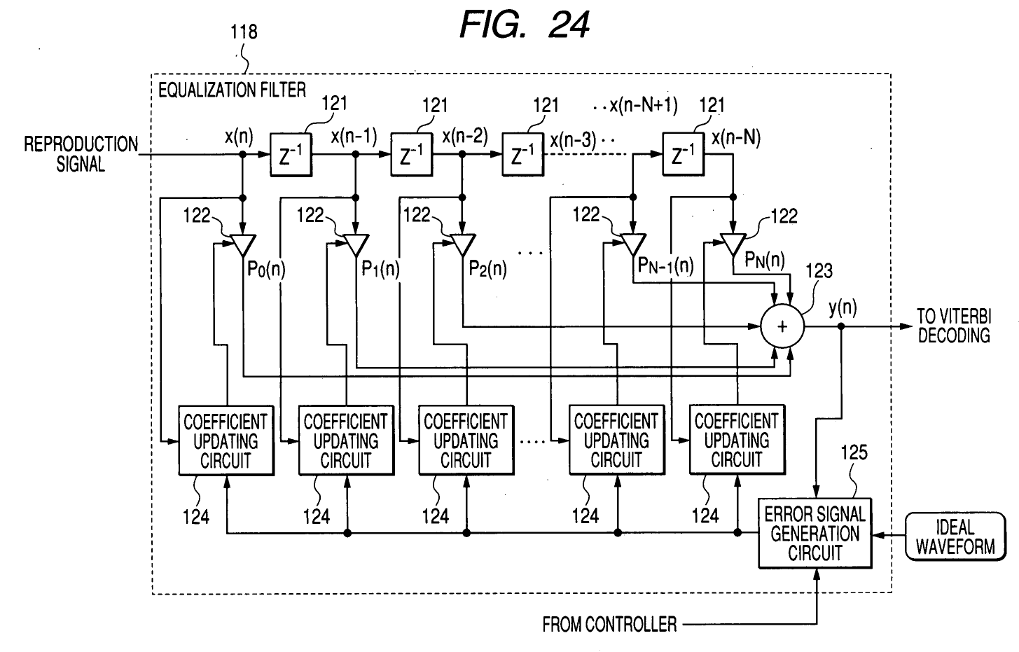

The eighth embodiment of the present invention is explained next. FIG. 23 is a block diagram that shows the constitution of the eighth embodiment, and FIG. 24 is a circuit diagram that shows a configuration of an equalization filter. The parts of FIG. 23 which are the same as those of FIG. 15 are denoted by the same reference numerals. Equalization filter adjustment is explained in this embodiment.

Parts before and after the correction circuit 114 in this embodiment differ from those of FIG. 15. A reproduction signal is directly inputted to the correction circuit 114, without passing through an amplitude measuring circuit, and output after correction is inputted to an equalization filter 118. Further, signals that have undergone waveform equalization are inputted to a reproduction signal processing circuit (not shown), and inputted to the reproduction signal amplitude measuring circuit 113. The measured reproduction amplitude after passing through the equalization filter is inputted to the controller 115.

Adjustment of the equalization filter is performed by performing focus control and tracking control in a state similar to the normal mode on an adjustment track on which a predetermined signal has been recorded in advance, similarly to the first embodiment.

As shown in FIG. 24, the equalization filter 118 is configured by an N-tap FIR adapted filter. A reproduction signal x(n) is outputted as a filter output y(n) as the sum (output from an adder 123) of outputs from N-1 delay units 121 and N coefficient multipliers 122. Further, reference numeral 124 denotes coefficient renewal circuits, and reference numeral 125 denotes an error signal generation circuit.

Operations for adjusting the equalization filter are performed as described below. First, the reproduction signal x(n), which is outputted from the correction circuit 114, passes through the N-tap FIR filter, and is outputted as the filter output y(n). The output is inputted to a Viterbi decoder (not shown) and to the error signal generation circuit 125. When coefficient renewal operations on the equalization filter are permitted by the controller 115, the error signal generation circuit 125 calculates the difference between an ideal waveform and the filter output y(n), multiplies the difference by a predetermined coefficient, and outputs the result to the coefficient renewal circuits 124.

When a test pattern stored in advance in a predetermined location on the optical disk 101 is regenerated as in this embodiment, an ideal waveform is known in advance. Accordingly, the ideal waveform may be outputted and compared to the regenerated test pattern.

Each of the coefficient renewal circuits 124 multiplies the signal outputted from the error signal generation circuit 125 by the signal inputted to each of the functional multipliers 122, adds the current coefficient, and sets this as the next coefficient.

The coefficient is optimized by continuing those operations, the error approaches zero, and the equalization filter adjustment operations converge. At the point of convergence, the controller 115 prohibits coefficient renewal operations (the controller 115 sets the output of the error signal generation circuit to zero, regardless of the input signal).

During adjustment, the correction circuit 114 multiplies the reproduction signal outputted by the detection circuit 103 by a table value corresponding to the value of the focus error at that time, and outputs the reproduction signal, whose amplitude has been corrected, to the equalization filter 118. The equalization filter 118, to which coefficient renewal has been permitted by the controller 115, performs renewal operations based on the corrected renewal signal.

Operation of the correction circuit 114 is substantially similar to the operation of the fourth embodiment. However, while in the fourth embodiment the amplitude of the reproduction signal measured during a predetermined period is multiplied by the value from the correction table, in this embodiment the reproduction signal is multiplied by the correction table in realtime.

Further, a relationship between the focus offset amount and the reproduction signal amplitude can also be measured in this embodiment when focus offset adjustment is performed before adjustment of the equalization filter, and a correction table can also be made using this data. In this case, the optical disk and the optical pickup actually employed are used, and correction can therefore be performed with improved accuracy.

Further, during adjustment processes in a factory before delivery, the offset may be changed and the reproduction amplitude may be measured by using a standard disk, and inverse table values based on the measured reproduction amplitude values may be stored in an EEPROM or the like and used. In this case, the relationship between the servo offset and the amplitude is influenced more greatly by differences in the optical pickup than by differences in optical disks. Accordingly, it becomes possible to perform correction in consideration of differences in the optical pickup that is more accurate than that of a method using a standard table, and correction can be performed with improved accuracy.

Furthermore, although the size-of the focus error signal is regarded as an item to correct the influence of external disturbances, the size of the tracking error signal may also be observed and both correction methods may be performed at the same time. In this case, it becomes possible to minimize the influence of external disturbances on both focus and tracking.

Further, correction according to other correction items such as the position of the objective lens may also be performed at the same time.

According to this embodiment, a reproduction signal amplitude value corrected by the correction table is used during operations of adjusting the equalization filter, and it therefore becomes possible to minimize the influence of external disturbances such as vibrations, even when the focus error becomes large for an instant due to the external disturbances such as vibrations. Further, it becomes possible to complete the adjustment within a fixed period of time because adjustment is not restarted from the beginning due to vibrations. In addition, index detection is even possible even under continuous vibrations. Accordingly, the adjustment always converges.

This application claims priority from Japanese Patent Application Nos. 2004-039944 filed Feb. 17, 2004 and 2004-067406 filed on Mar. 10, 2004, which are hereby incorporated by reference herein.

1. An optical information recording and reproducing apparatus which performs recording of information by irradiating a recording medium with spot light, and performs reproduction of information by receiving reflected light from the recording medium, the optical information recording and reproducing apparatus comprising:
a servo error signal generating circuit for generating a servo error signal based on light reflected by the recording medium;
a servo control circuit for performing servo control of the spot light based on the servo error signal;
a reproduction index detection circuit for detecting a reproduction index showing a quality of a reproduction signal from the recording medium; and
an adjustment circuit for performing adjustment of an offset value of the servo control circuit, or performs adjustment of a recording and reproduction parameter, based on the reproduction index,
wherein the adjustment circuit performs adjustment by correcting or invalidating the reproduction index when there is an abnormality in the servo control.

2. An optical information recording and reproducing apparatus according to claim 1, wherein the adjustment circuit changes the offset value or the parameter in a manner of steps, detects the offset value or the reproduction index corresponding to the parameter in each of the steps, and makes the reproduction index invalid in a step where there is an abnormality in the servo control.

3. An optical information recording and reproducing apparatus according to claim 1, wherein the servo control circuit detects an abnormality in the servo control when a level of the servo error signal is equal to or greater than a predetermined value or when the level of the servo error signal is equal to or less than the predetermined value.

4. An optical information recording and reproducing apparatus according to claim 3, wherein the servo error signal is a focus error signal, a tracking error signal, or a lens position signal for an objective lens.

5. An optical information recording and reproducing apparatus according to claim 2, wherein the reproduction index detection circuit detects a value of the reproduction index a predetermined number of times, sets an average value of the detected values to the reproduction index in each of the steps, and does not count a case where the reproduction index is invalid as a detection number.

6. An optical information recording and reproducing apparatus according to claim 1, wherein the servo control circuit detects an abnormality in the servo control according to an existence of vibrations or flaws on the recording medium during the adjustment of the offset value or the parameter.

7. An optical information recording and reproducing apparatus according to claim 2, further comprising a circuit for determining whether or not the offset value is within a predetermined range, based on the servo error signal, wherein adjustment processing is interrupted when the offset value falls outside of the predetermined range.

8. An optical information recording and reproducing apparatus according to claim 1, wherein the offset value is a value of a focus offset, a tracking offset, or a lens position signal.

9. An optical information recording and reproducing apparatus according to claim 1, wherein the recording and reproduction parameter is a recording power value, a reproduction power value, a spherical aberration correction value, or an equalization filter coefficient.

10. An optical information recording and reproducing apparatus according to claim 1, wherein the reproduction index is a reproduction signal amplitude, a jitter of the reproduction signal, an error rate of the reproduction signal, or an amplitude of a tracking error signal.

11. An optical information recording and reproducing apparatus according to claim 1, wherein the adjustment circuit corrects the reproduction index according to a size of a predetermined error signal having a correlation to the reproduction index.

12. An optical information recording and reproducing apparatus according to claim 11, wherein the predetermined error signal is a focus error signal, a tracking error signal, a lens position signal of an objective lens, or a spherical aberration error signal.

13. An optical information recording and reproducing apparatus according to claim 12, wherein the adjustment circuit corrects the reproduction index according to a correction table based on the predetermined error signal.

14. An optical information recording and reproducing apparatus according to claim 12, wherein the adjustment circuit corrects the reproduction index according to a correction function based on the predetermined error signal.
